(19) United States
(12) Patent Application Publication
(10) Pub. No.: US 2023/0317975 A1
(43) Pub. Date: Oct. 5, 2023

(54) FLOW FIELD PLATE AND METHOD FOR PRODUCING SAME

(71) Applicant: CELLCENTRIC GMBH & CO. KG, Kirchheim unter Teck (DE)

(72) Inventors: Hubertus REHERMANN, Deizisau (DE); Linda KINLECHNER, Stuttgart, DE (US); Thomas SCHEFFLER, Stuttgart (DE); Philipp HAUSMANN, Kirchheim unter Teck (DE); Sven PEGEL, Kirchheim unter Teck (DE)

(21) Appl. No.: 18/042,377

(22) PCT Filed: Jul. 30, 2021
(86) PCT No.: PCT/EP2021/071410

§ 371 Date: Feb. 21, 2023

(30) Foreign Application Priority Data
Aug. 24, 2020 (DE) 10 2020 005 165.0

(51) Int. Cl. H01M 8/0243; H01M 8/0258; H01M 8/0239; H01M 8/0234

(52) U.S. Cl. CPC H01M 8/0243; H01M 8/0258; H01M 8/0239; H01M 8/0234; H01M 2008/1095

(57) ABSTRACT

The invention relates to a flow field plate (1) for a fuel cell, consisting of a synthetic resin (A-B) with fillers that comprise at least graphite (C) and/or carbon black. The flow field plate (1) according to the invention is characterized in that a polyurethane resin (PUR) is used as the synthetic resin (A-B).

The invention relates to a flow field plate for a fuel cell according to the type defined in more detail in the preamble of claim 1. The invention also relates to a method for producing a flow field plate for a fuel cell.

Flow field plates for fuel cells are known per se in the art. Such flow field plates are produced from different materials, all of which must be designed to be electrically conductive. The flow field plates are therefore often made of metal. They delimit the respective individual cells in a so-called fuel cell stack and ensure the supply and removal of educts and products to the electrodes and membranes. They are often formed from two individual plates pressed against one another with their rear sides, between which a cooling medium can also flow. On one side of this flow field plate is the anode of the single cell, on the other side is the cathode of the neighboring single cell, which in turn is separated from the respective next flow field plate by a so-called MEA (membrane electrode arrangement) and thus, together with the surfaces facing each other of two adjacent flow field plates, forms the actual single cell.

In addition to metallic flow field plates, flow field plates made of plastic or electrically conductive ceramics are also known from the prior art. Flow field plates made of plastics are often produced as systems bonded with phenolic resin, which, however, have a relatively low strength. Furthermore, epoxy resin-bound systems are known. Both require relatively long process cycle times and require a high energy input, since it is a hot-temperature process that takes place at 150 to 180° C. Graphite and/or carbon black in finely powdered or finely flaked form is usually used as the electrically conductive filler, fine in this context meaning that the average size of the particles or flakes is in the micrometer or nanometer range.

The entire process is relatively complex. For example, it can be designed in such a way that a cuboid blank is first produced and then pressed in order to create the required structures such as flow channels, openings and the like in the flow field plate. Often, a subsequent annealing process is needed in order to ensure the required permanent geometric shape of the plates without warping or the like. All of this is relatively complex and energy-consuming. The required press forces are relatively high in such processes, so that there is also a considerable wear of the tools. Expanded graphites for the production of flow field plates are also known from US 2007/0111078 A1. The problem here is the non-permanent dimensional stability and the extraordinarily low strength of the flow field plates. This low strength requires a corresponding construction of the flow field plates with a relatively large wall thickness in order to at least achieve the required minimum strength. However, such large wall thicknesses result in a relatively large increase in the thickness of the structure of the flow field plates, which is a disadvantage with regard to the power density in a fuel cell stack.

The object of the present invention is to specify an improved, more stable and cost-optimized flow field plate and a method for producing same.

According to the invention, this object is achieved by a flow field plate having the features of claim 1, and here in particular in the characterizing part of claim 1. A method for producing a flow field plate, which achieves the object, is specified in claim 7, and again in particular in the characterizing part of claim 7. Advantageous configurations and refinements both of the flow field plate and of the method for producing a flow field plate result from the respective dependent claims.

The flow field plate according to the invention is based on a synthetic resin system with a filler, comparable to the flow field plate from the prior art. In contrast to the disadvantageous epoxy and phenolic resin systems mentioned above, the flow field plate according to the invention is based on a polyurethane resin, which enables numerous advantages over the previous phenolic resin or epoxy resin-bound systems. A crucial advantage of such a flow field plate, which is based on a polyurethane-based resin, is its better mechanical properties, which enable relatively high strength with low brittleness. The flow field plates are therefore significantly more robust in assembly and operation, which makes the structure extremely efficient and advantageous in producing the fuel cell stack and the handling thereof.

Advantageously, polyurethane resins can be cured at so-called warm temperatures of 50 to 60° C., while hot temperatures of 150 to 180° C. are required for epoxy or phenolic resin systems. This temperature saving of approx. 100° C. and the possibility of completely dispensing with a post-annealing process represents an enormous energy saving in production and allows significantly longer tool life, which leads to a further crucial cost advantage in the case of the flow field plate according to the invention. It is furthermore advantageous to be able to produce a foldable flow field plate due to the high strength and flexibility of the polyurethane resin systems, which can save sealing points in the overall structure of the fuel cell stack, which is also a crucial advantage.

According to an advantageous refinement of the flow field plate according to the invention, the polyurethane resin can be produced from two liquid starting components, one of which comprising an isocyanate or a polyisocyanate. According to an advantageous refinement, the other starting component can include polyols. In principle, other polyurethane resin systems are also conceivable. However, the use of isocyanate or polyisocyanate and polyol has proven particularly efficient. The liquid starting components can be mixed accordingly and cured to form the resin system.

According to an extraordinarily favorable refinement of the flow field plate according to the invention, it is provided that both liquid starting components are provided with graphite and/or carbon black as a filler. This has the advantage that the liquid, unmixed starting components have a relatively low viscosity, so that the graphite as a filler, which, according to an advantageous embodiment, is technically very pure, preferably synthetic graphite and/or carbon black, can be mixed relatively homogeneously and uniformly with the respective starting component. If the two starting components that have already been mixed with this filler are then mixed in turn, an extraordinarily efficient and uniform distribution of the filler can be achieved.

In principle, other fillers are also conceivable in one or both of the starting components, for example fibers or similar fillers, which further increase the mechanical strength. Particularly preferably, however, only graphite and/or carbon black are/is used as a filler, since an extraordinarily homogeneous distribution of the graphite with a very homogeneous conductivity of the flow field plate can be achieved in this case. Preferably, more than 60 to 70% by volume, particularly preferably approx. 80% by volume, of the mixed starting components are fillers, in particular graphite. The production method according to the invention provides that the flow field plate for a fuel cell is produced from a synthetic resin with at least one filler, with two starting components being cured to form the synthetic resin. According to the invention, the starting components used are those that form a polyurethane resin, these components being mixed in the liquid state and then at least partially or temporarily cured during production in a tool that generates the structure of the flow field plate under the action of temperature. Such a tool can form the structure, for example the so-called header and the flow field, i.e. the flow channels for distributing the media and for guiding the media from one plate to the next, in the material, so that the flow field plate can be produced more or less in an out-of-tool manner. This is particularly easy and efficient. Temperatures in the range of 50 to 60° C. are sufficient for starting a homogeneous curing process, so that this can also be provided accordingly in the method according to an advantageous refinement.

According to a very advantageous configuration of the method according to the invention, the starting components are polyols and isocyanate, both of which are provided with graphite as a filler before mixing. Thus, the starting components are pre-filled with the graphite as a filler, which enables a very uniform and homogeneous distribution in each of the starting components. Thereafter, these starting components are appropriately mixed so that there is still a very homogeneous mixture and in particular a very homogeneous distribution of the graphite as the filler, which ensures the electrical conductivity of the structure of the flow field plate. The starting components mixed in this way are then cured with their respective filler, in this case the graphite. At least temporarily, they are in contact with a shaping surface of the tool.

According to an advantageous refinement of the idea, the starting components can be pressed into the tool or held in it at least temporarily under pressure. Various tools are conceivable that contain the structure of the flow field plate and transfer it to the curing polyurethane resin system. For example, this can be open casting molds, closed injection molds or the like. Typically, they are heated to the temperature of about 50 to 60° C. that is useful for curing the mixture and, according to this advantageous refinement, are filled under pressure with the mixture of the starting components, which then cures completely or at least temporarily under pressure and/or in the tool, so that the flow field plate can preferably be produced in an out-of-tool manner.

A further decisive advantage of the production method is the fact that the fillers, in this case in particular or preferably exclusively, the graphite and/or carbon black, are mixed with the liquid starting components. This reduces the degree of contamination during production, since this mixing can take place directly in a relatively simple and efficient manner, in particular when producing the starting components. In the actual manufacture, only these liquid starting components provided with the filler are then mixed, which is typically possible without affecting the production line with graphite dust, which is another crucial advantage of the production method according to the invention and is also associated with a cost savings due to the reduction in contamination.

Further advantageous configurations of the flow field plate according to the invention and the method for its production also result from the exemplary embodiments, which are explained in more detail below with reference to the figures.

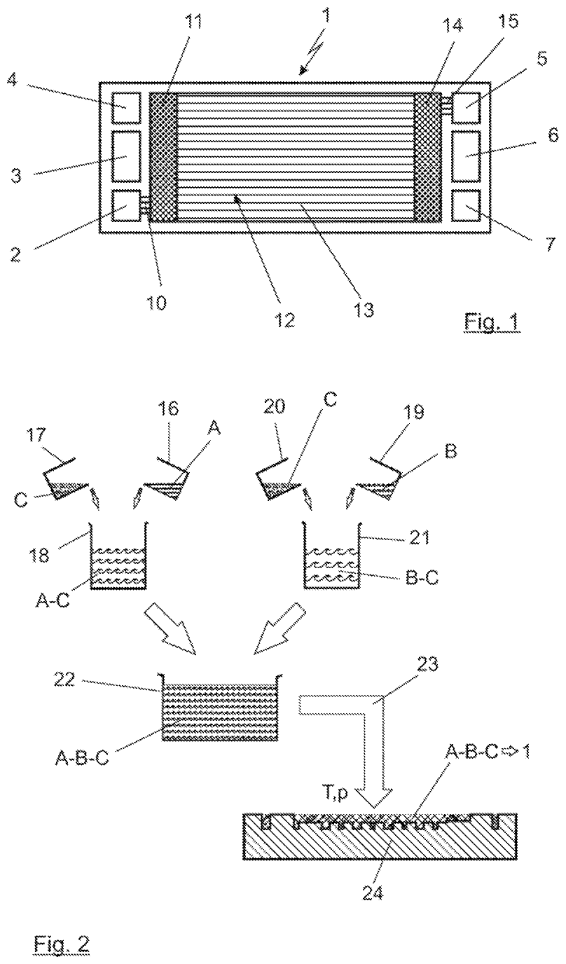

FIG. 1 shows a schematic view of a flow field plate in an exemplary geometric configuration comparable to the prior art; and

FIG. 2 shows a schematic representation of the method according to the invention.

FIG. 1 shows the plan view of a flow field plate labeled 1, for example the anode side of a flow field plate 1. Flow field plate 1 has on both sides, the so-called headers, several openings 2 to 7, which are used for the supply and removal of media. The exemplary embodiment shown here, shows the plan view on the surface of flow field plate 1 which faces the anode side of an adjacent single cell of a fuel cell stack, which is not shown in its entirety. It has, for example, the opening labeled 2 at the top right, which, together with comparable openings in adjacent flow field plates 1, forms a supply channel for hydrogen. Hydrogen then flows through said opening 2, which forms part of the supply channel, to each of the flow field plates 1 and into a collection or distribution area 11 of a flow field labeled 12 in its entirety via connecting channels labeled 10. Distribution area 11 has an open structure, for example with the nubs indicated here, in order to enable a transverse distribution of hydrogen. A channel structure 13 is located in the further course of the flow field 12 in the direction of flow. The gases are distributed to the anode side of the individual cell via said channel structure 13 having parallel channels that are closed to one another. The collection or distribution area 11 helps ensure that the flow through all the channels of channel structure 13 is as uniform as possible. After flowing through the channels of channel structure 13, the residual gas, mixed with the product water generated in the fuel cell, reaches a collection area labeled 14 and comparable to distribution area 11, in which the gas/liquid mixture accumulates. It then flows via connecting channels 15 on the outflow side into the opening labeled 5 which, together with further analogous openings in adjacent flow field plates 1, forms a discharge channel 16.

The structure for the cathode side of the adjacent single cell on the opposite side of flow field plate 1 looks substantially the same. The air or the oxygen is supplied, for example, via opening 4 and correspondingly discharged via opening 7. Openings 3 and 6, which are somewhat larger in cross section in most structures, are provided for the supply and removal of liquid cooling medium, for example cooling water. It is often the case that flow field plates 1 are formed from two partial plates, which are connected to one another at their rear sides. They then form further channels between their rear sides, through which cooling liquid can flow via openings 3 and 6. All of this is known to the person skilled in the art so that it does not need to be discussed further.

The special feature of flow field plate 1 is its material. Said flow field plate 1 consists of a polyurethane resin (PUR), which is produced with an electrically conductive filler in the form of graphite and/or carbon black in the manner described in more detail below. Such a polyurethane resin system for flow field plate 1 provides extraordinary flexibility and high strength with good functionality. The production method enables further energetic and process-related advantages compared to the synthetic resin-bonded systems according to the prior art.

The production method is indicated schematically in the illustration of FIG. 2. A first starting component A, which is indicated here by way of example in a container 16, is provided with graphite C in an indicated container labeled 17. The two substances are appropriately mixed in container 18 so that there is a mixture A-C. Starting component A can preferably be polyols, while the filler in the form of graphite C is synthetic graphite with a correspondingly small particle size on the order of a few microns. Graphite C can be distributed very homogeneously and uniformly in the liquid starting component A.

A similar procedure is shown on the right-hand side of FIG. 2. A starting component labeled B in a container 19 is also mixed with graphite C from a container 20 so that there is a mixture B-C made of second starting component B and graphite C in container 21. The same features and parameters apply to the graphite here as were previously described in the left-hand part of the figure when mixing the graphite C with first starting component A. Second starting component B, which is also in liquid form and is mixed with graphite C, is isocyanate. The starting components A-C and B-C, which have each been mixed with graphite C and are still liquid, are then mixed with one another so that there is a component mixture A-B-C in the container labeled 22, wherein, due to the fact that graphite C has been premixed already with the individual liquid starting components A, B, an extremely homogeneous mixture can be achieved.

The proportion of graphite in this mixture is approx. 80% by volume. The uniform and homogeneous distribution ensures later on an even and homogeneous electrical conductivity of flow field plate 1, which is to be produced from mixture A-B-C.

As indicated by arrow 23, said mixture A-B-C is then added into a tool 24 having a structure which is designed as a negative of the structure desired in flow field plate 1. At a temperature T of approx. 50 to 60° C. and, optionally, at a pressure P above atmospheric pressure, mixture A-B-C then cures in tool 24 to form flow field plate 1, with the entire curing process not necessarily having to take place in tool 24, but, optionally, only part of the same can take place there. The structure is then extremely stable, has low porosity and relatively high flexibility, so that flow field plate 1 can be out-of-tool and without further method steps such as tempering or the like. As already mentioned above, different types of tools 24 are possible, so that it is clear to the person skilled in the art that tool 24 indicated in FIG. 2, which is shown here by way of example as an open casting mold, only represents one possible exemplary embodiment.

1. A flow field plate for a fuel cell made of a synthetic resin with fillers which comprises at least graphite and/or carbon black,
wherein
a polyurethane resin is used as the synthetic resin.
the polyurethane resin (A-B) is produced from two liquid starting components (A, B), one of which comprises isocyanate (B) or polyisocyanate and/or one of which comprises polyols (A), and
both starting components (A, B) are provided with graphite (C) and/or carbon black as a filler.

2. (canceled)

3. (canceled)

4. (canceled)

5. The flow field plate according to claim 1,
wherein
the fillers make up more than 60 to 70% by volume, preferably approx. 80% by volume, of the finished component.

6. The flow field plate according to claim 1,
wherein
pure, preferably synthetic, graphite and/or carbon black are/is used as the sole filler.

7. A method for producing a flow field plate for a fuel cell made of a synthetic resin with a filler, wherein at least two starting components are cured to form the synthetic resin,
wherein
the starting components used are those that form a polyurethane resin and being mixed in liquid form and then cured at least temporarily in a tool that generates the structure of the flow field plate under the action of temperature, and the starting components (A, B) used are polyols (A) and isocyanate (B), both of which are provided with graphite (C) and/or carbon black as filler prior to mixing.

8. (canceled)

9. The method according to claim 7,
wherein
a temperature of approx. 50 to 60° C. is specified at least to start curing.

10. The method according to claim 7,
wherein
the starting components together with the filler are pressed into the tool and/or held in it at least temporarily under pressure.

11. The flow field plate according to claim 2,
wherein
the fillers make up more than 60 to 70% by volume, preferably approx. 80% by volume, of the finished component.

12. The flow field plate according to claim 3,
wherein
the fillers make up more than 60 to 70% by volume, preferably approx. 80% by volume, of the finished component.

13. The flow field plate according to claim 4,
wherein
the fillers make up more than 60 to 70% by volume, preferably approx. 80% by volume, of the finished component.

14. The flow field plate according to claim 5,
wherein
pure, preferably synthetic, graphite and/or carbon black are/is used as the sole filler.

15. The method according to claim 9,
wherein
the starting components together with the filler are pressed into the tool and/or held in it at least temporarily under pressure.
